(19) United States
(12) Patent Application Publication
(10) Pub. No.: US 2015/0213090 A1
(43) Pub. Date: Jul. 30, 2015

(54) ESTIMATION DEVICE, DATABASE OPERATION STATUS ESTIMATION METHOD AND PROGRAM STORAGE MEDIUM

(71) Applicant: NEC CORPORATION, Minato-ku, Tokyo (JP)

(72) Inventor: Yasuhiro Ajiro, Tokyo (JP)

(21) Appl. No.: 14/427,707

(22) PCT Filed: Sep. 3, 2013
(86) PCT No.: PCT/JP2013/005209

§ 371 Date: Mar. 12, 2015

(30) Foreign Application Priority Data
Sep. 13, 2012 (JP) 2012-201748

(51) Int. Cl. G06F 17/30

(52) U.S. Cl. CPC G06F 17/30469; G06F 17/3048

(57) ABSTRACT

Provided is a technology which can estimate, in advance before integrating a plurality of databases (instances), an operation status of a database after the integration, such as a buffer cache hit rate. An estimation device 1 includes an acquisition unit 2 and an estimation unit 3. The acquisition unit 2 acquires information on operation statuses of respective databases to be integrated together. The estimation unit 3 generates, using the acquired operation statuses, an equation expressing a relationship between the operation status of the target database and capacity of the buffer cache correlated to the target database. The estimation unit 3 further estimates an operation status of an integrated database after integrating the plurality of the target databases based on the generated equation and capacity of an integrated buffer cache correlated to the integrated database.

### TECHNICAL FIELD

The present invention relates to technology of estimating an operation status of a database (a hit rate of a buffer cache and a physical IO (Input Output) per second).

### BACKGROUND ART

Patent Literature 1 (PTL 1) discloses a device (cache hit rate estimating device) that estimates a cache hit rate. The cache hit rate is a probability that data designated by a data read instruction (an instruction requesting for reading data) has been cached in a cache device. The cache hit rate estimating device disclosed in PTL 1 measures a reading status of data cached in the cache device and, using the measured value, estimates the cache hit rate.

Non Patent Literature 1 (NPL 1) describes calculating a cache hit rate H according to an equation (1) based on the working set method.

$$H = {\sum }_{x} ( {π}_{x} \times {P}_{r} \{ {D}_{x} ≦ T \} ) \qquad ( 1 )$$

Where, the x in the equation (1) represents an object (data to be read). The Dₓ represents a time interval (reference interval) at which the object x is referred to (read). The πₓ represents a probability that the object x is referred to. The Pᵣ{D_{R}≦T} represents a probability that the object x is referred to within a time T.

### CITATION LIST

### Patent Literature

[PTL 1] Japanese Patent Application Laid-Open No. 2005-339198

### Non Patent Literature

[NPL1] Atsuhiro Tanaka, “Cache modeling and its applications”, Operations Research, Vol. 49, July 2004, pp. 434-437

### SUMMARY OF INVENTION

### Technical Problem

In a database system, a memory area to function as a buffer cache is allocated to each instance, which is the unit of database management, in a main memory of a computer (server) which manages the database. A large-scale database system is constructed of a plurality of servers and a plurality of storage devices (hard disk devices), because it is often the case that the process cannot be dealt with by only one server and only one storage device.

To the contrary, in recent years, there has been a case where a plurality of instances having been separated because of performance-related reason are integrated (unified) into a single instance. One of the reasons is that performance of a CPU (Central Processing Unit) has been increased as a result of increase in the number of CPU cores. Another reason is appearance of a flash memory drive (SSD (Solid State Drive)).

It is occasionally desired that, for the purpose of the system design, for example, before integrating the instances (in other words, before integrating databases), an operation status of a database after integrating a plurality of instances is estimated. The operation status of the database is represented by, for example, a buffer cache hit rate.

However, there has been a problem in that, even if it is intended to estimate, before integration of databases, the operation status of the integrated database by using the technologies described in PTL 1 and NPL 1, the estimation is difficult. Specifically, in the technologies described in PTL 1 and NPL 1, a measured value (actually measured value) relating to data reading is used for estimating the cache hit rate. However, it is impossible to obtain, before database integration, such measured value (actually measured value) on the integrated database. For this reason, it is impossible to estimate the cache hit rate for the integrated database by using the technologies described in PTL 1 and NPL 1.

The present invention has been achieved for the purpose of solving the above-described problem. That is, the main object of the present invention is to provide a technology which can estimate, in advance before integrating a plurality of databases (instances), an operation status of a database after the integration, such as a buffer cache hit rate.

### Solution to Problem

An estimation device of the present invention includes:

an acquisition unit that acquires information on an operation status of each of databases which are integration targets to be integrated; and

an estimation unit that generates, by using the acquired operation status, an equation expressing a relationship between the operation status of the database to be the integration target and capacity of a buffer cache correlated to the database, and then estimating an operation status of an integrated database generated by integrating the plurality of databases to be the integration targets, based on the generated equation and capacity of an integrated buffer cache which is correlated to the integrated database.

A database operation status estimation method of the present invention includes:

acquiring, by a computer, information on an operation status of each of databases which are integration targets to be integrated;

generating, by a computer, an equation expressing a relationship between the operation status of the database to be the integration target and capacity of a buffer cache correlated to the database based on the acquired operation status; and

estimating, by a computer, an operation status of an integrated database generated by integrating the plurality of databases to be the integration targets, based on the generated equation and capacity of an integrated buffer cache which is correlated to the integrated database.

A computer program storage medium of the present invention, the computer program storage medium stores a computer program that cause a computer to execute:

processing to acquire information on an operation status of each of databases which are integration targets to be integrated;

processing to generate, by using the acquired operation status, an equation expressing a relationship between the operation status of the database to be the integration target and capacity of a buffer cache correlated to the database; and

processing to estimate an operation status of an integrated database generated by integrating the plurality of databases to be the integration targets, based on the generated equation and capacity of an integrated buffer cache which is correlated to the integrated database.

Further, the main object of the present invention can be achieved also by the database operation status estimation method corresponding to the estimation device of the present invention having the above-described configuration. The main object of the present invention can be achieved also by the computer program which realizes the estimating device and the database operation status estimation method of the present invention by means of a computer, and also by the storage medium which stores the computer program.

### Advantageous Effects of Invention

According to the present invention, it is possible to estimate, in advance before integrating a plurality of databases (instances), an operation status of a database after the integration, such as a buffer cache hit rate.

### BRIEF DESCRIPTION OF DRAWINGS

FIG. 1 is a block diagram showing, in a simplified manner, a configuration of an estimation device in a first exemplary embodiment according to the present invention.

FIG. 2 is a block diagram illustrating a hardware configuration to realize the estimation device in the first exemplary embodiment.

FIG. 3 is a model diagram showing, in an image, an example (1) of a change in hardware configuration between before and after integration of databases.

FIG. 4 is a model diagram showing, in an image, an example (2) of a change in hardware configuration between before and after integration of databases.

FIG. 5 is a model diagram showing, in an image, an example (3) of a change in hardware configuration between before and after integration of databases.

FIG. 6 is a block diagram showing, in a simplified manner, a configuration of an estimation device in a second exemplary embodiment according to the present invention.

FIG. 7 is a block diagram showing, in a simplified manner, an example of a configuration of a database management system.

FIG. 8 is a graph illustrating a relation between capacity of a buffer cache correlated to a database and a hit rate.

### DESCRIPTION OF EMBODIMENTS

Hereinafter, exemplary embodiments according to the present invention will be described, with reference to drawings.

### First Exemplary Embodiment

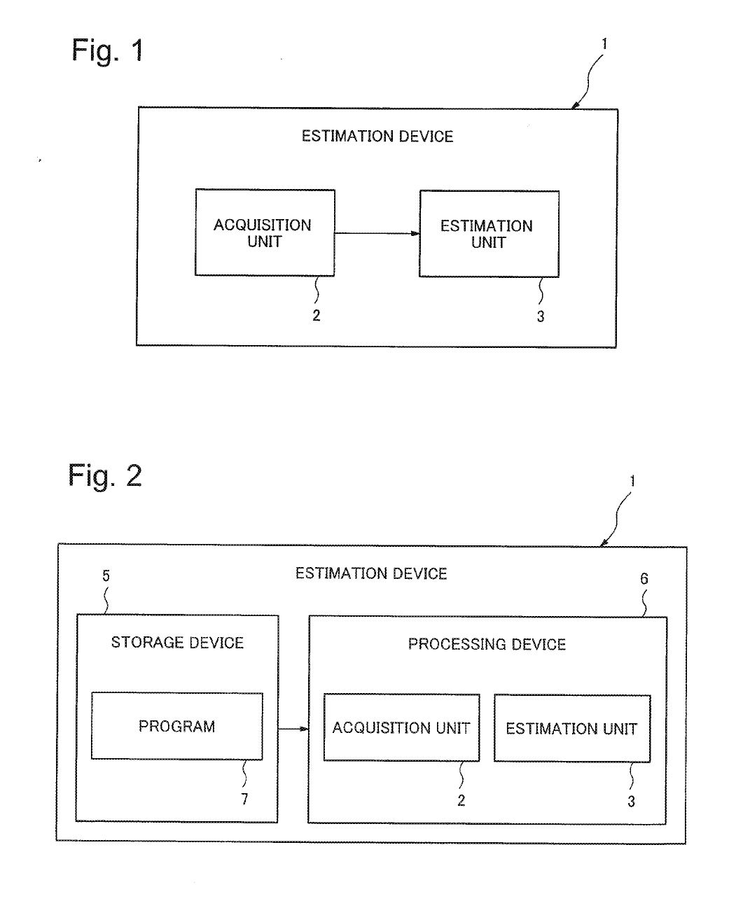

FIG. 1 is a block diagram showing, in a simplified manner, a configuration of an estimation device in a first exemplary embodiment according to the present invention. The estimation device 1 of the first exemplary embodiment is a device which can estimate, before integrating a plurality of databases, an operation status of a database after the integration.

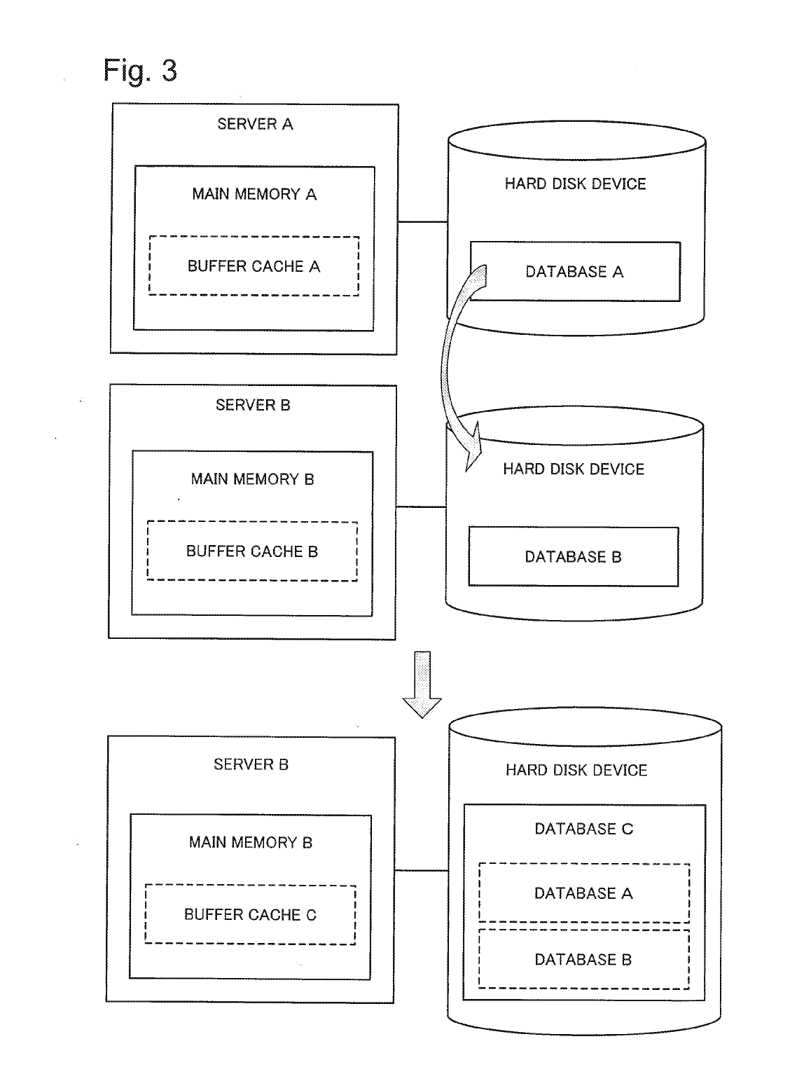

Here, a description will be briefly given of a change in hardware configuration between before and after integration of databases. FIG. 3 is a model diagram showing, in an image, an example (1) of a change in hardware configuration between before and after integration of databases. In FIG. 3, a database A is managed by a server A before integration of databases. In a main memory A of the server A, a memory area which functions as a buffer cache A correlated to the database A is allocated (set). A database B is managed by a server B. In a main memory B of the server B, a memory area which functions as a buffer cache B correlated to the database B is allocated (set).

In the example in FIG. 3, the database A is added (integrated) into a hard disk device (storage device) storing the database B, and a database C is thereby constructed. In this time, information (management information and the like) related to the database A stored in the server A is added into the server B. Further, in the main memory B of the server B, a memory area which functions as a buffer cache C correlated to the database C is allocated. By such the integration process, a database management system (DBMS) in which the server B manages the database C as a single instance (database management unit) is constructed.

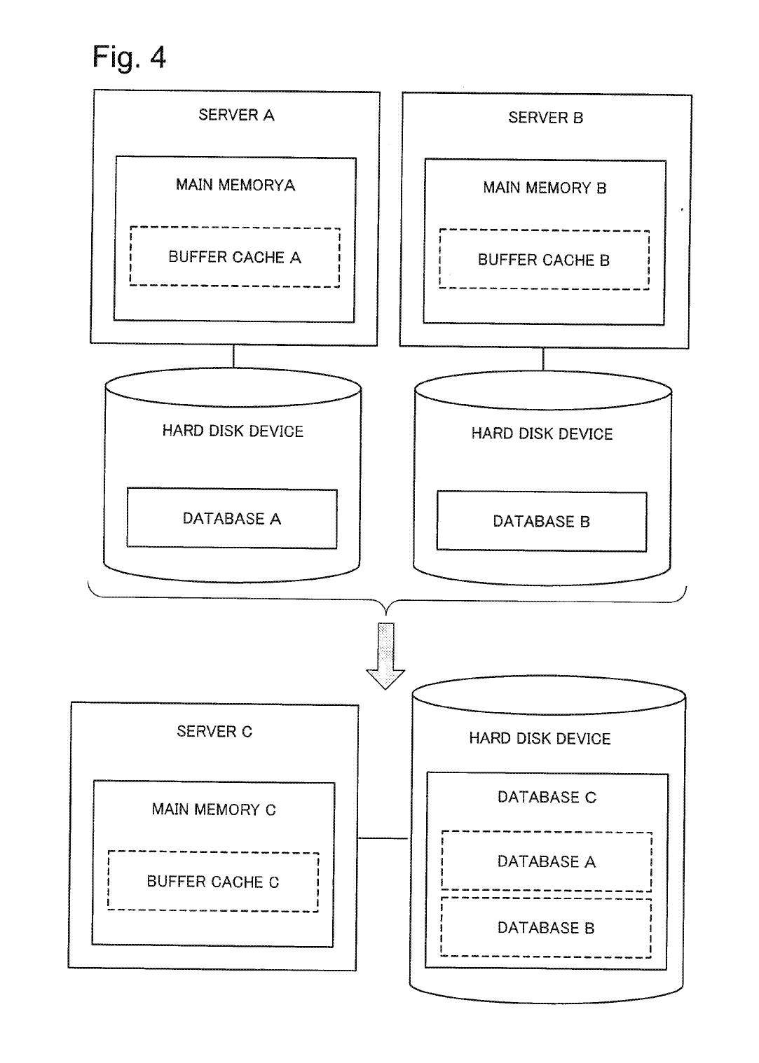

FIG. 4 is a model diagram showing, in an image, an example (2) of a change in hardware configuration between before and after integration of databases. In this example (2) of the change, a database A managed by a server A and a database B managed by a server B are integrated together into a hard disk device managed by a server C. As a result, a database C is constructed. In this time, information (management information and the like) related to the database A and B are transferred from the servers A and B, respectively, to the server C. Further, in the main memory C of the server C, a memory area which functions as a buffer cache C correlated to the database C is allocated. By such the integration process, a database management system (DBMS) in which the server C manages the database C as a single instance is constructed.

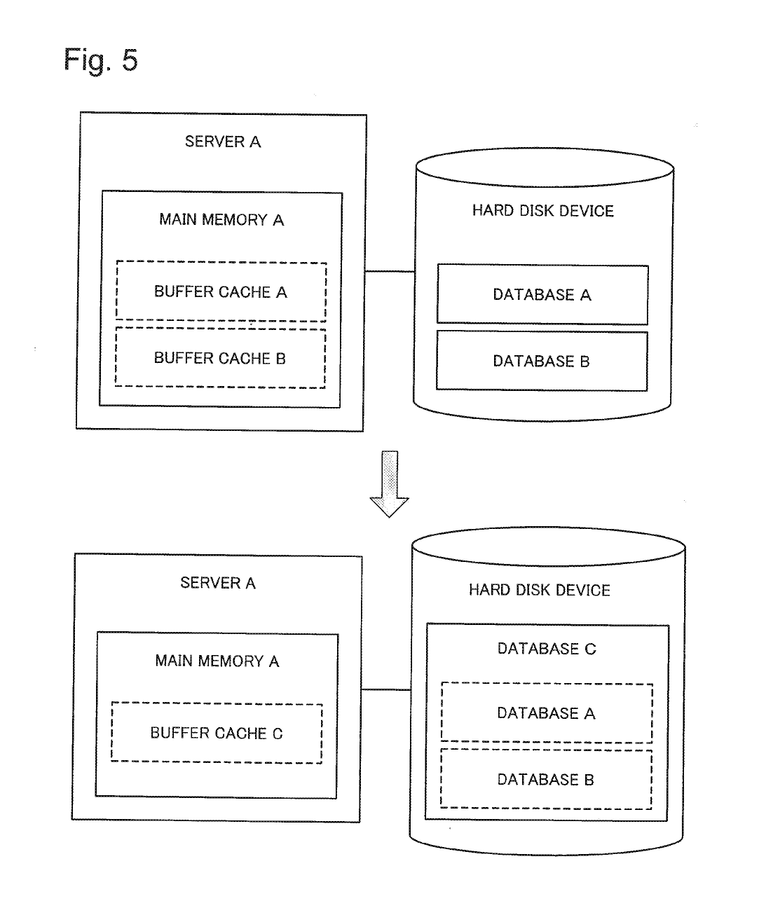

FIG. 5 is a model diagram showing, in an image, an example (3) of a change in hardware configuration between before and after integration of databases. In this example (3) of change, databases A and B both managed by a server A are integrated together, and a database C is thereby constructed. In this time, in the server A, information (management information and the like) related to the database A and B are integrated together. Further, a memory area which functions as a buffer cache C correlated to the database C is allocated in the main memory A. By such the integration process, a database management system (DBMS) in which the server A manages the database C as a single instance is constructed.

The estimation device 1 of the first exemplary embodiment is a device which can estimate an operation status of a database after being constructed by database integration in the above-described manners. The estimation device 1 includes an acquisition unit (acquisition means) 2 and an estimation unit (estimation means) 3, as shown in FIG. 1. Here, the estimation device 1 may be installed inside a management device (server) configuring a database management system, or may be a device separated from the management device.

The acquisition unit 2 has a function to acquire information on operation statuses of respective databases to be integrated together (hereafter, also referred to as target databases). The estimation unit 3 has a function to generate, using the acquired operation statuses, an equation expressing a relationship between the operation status of the target database and capacity of the buffer cache correlated to the target database. The estimation unit 3 further has a function to estimate an operation status of an integrated database generated by integrating the plurality of the target databases based on the generated equation and capacity of an integrated buffer cache correlated to the integrated database.

As has been described above, in case of integrating a plurality of the target databases together to construct the integrated database, the estimation device 1 of the first exemplary embodiment acquires the operation status of each of the databases (target databases) before the integration. Then, by using the operation statuses of the databases acquired before the integration, the estimation device 1 estimates the operation status of the database after the integration (integrated database). That is, the estimation device 1 can estimate the operation status of the integrated database without using any measured values relating to the operation status of the integrated database. Accordingly, the estimation device 1 can obtain (estimate) the operation status of the integrated database, in advance of integrating a plurality of databases (target databases).

The estimation device 1 of the first exemplary embodiment can be realized by, for example, hardware shown in FIG. 2. That is, the estimation device 1 shown in FIG. 2 includes a storage device 5 and a processing device 6.

The storage device 5 is a device storing a computer program (program) and data. For example, a RAM (Random Access Memory) and a hard disk device are used as the storage device 5. In the first exemplary embodiment, a program 7 including a procedure of controlling operation of the estimation device 1 is stored in the storage device 5. That is, the storage device 5 functions as a program storage medium storing the program 7.

The processing device 6 is configured by, for example, hardware resources including a CPU (Central Processing Unit). The processing device 6 realizes the acquisition unit 2 and the estimation unit 3 by reading the program 7 from the storage device 5 and then executing the program 7.

### Second Exemplary Embodiment

Hereinafter, a second exemplary embodiment according to the present invention will be described.

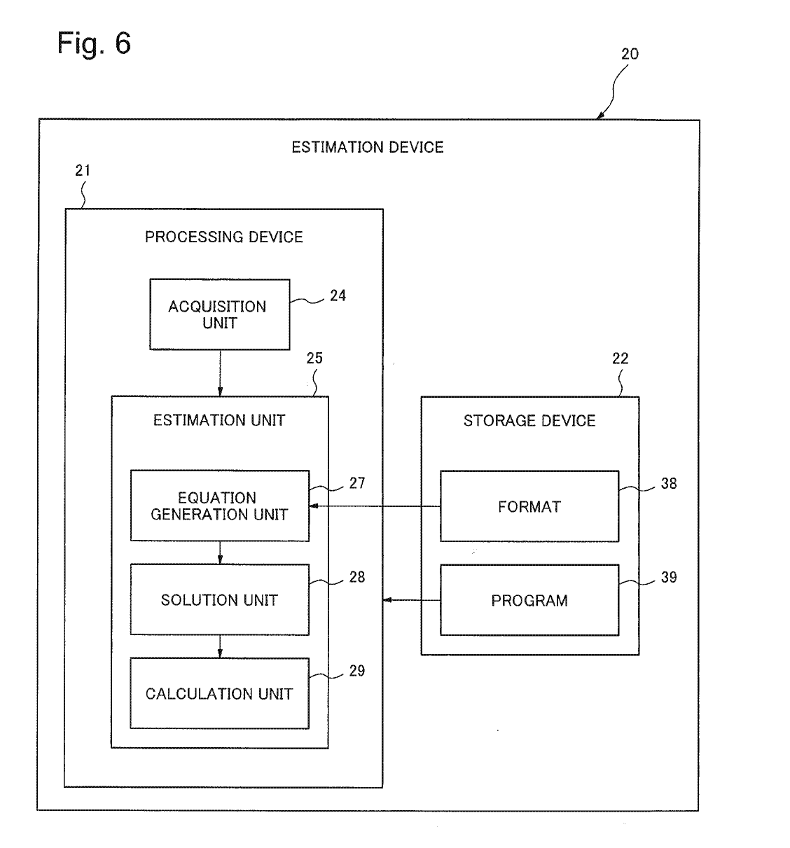

FIG. 6 is a block diagram showing, in a simplified manner, a configuration of an estimation device 20 in the second exemplary embodiment according to the present invention. This estimation device 20 is a device which estimates, before integrating databases in any one of the ways shown in FIGS. 3 to 5, the operation status of the database after the integration (integrated database).

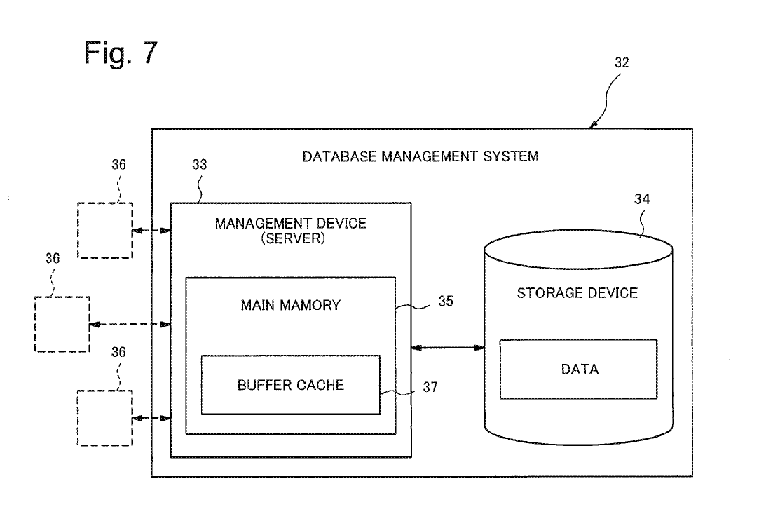

Here, as shown in FIG. 7, a database management system (DBMS) 32 includes a management device (server) 33 and a storage device 34, and functions as, for example, a server of a client server system. The management device 33 is a computer. The management device 33 is provided with a main memory 35, where an area functioning as a buffer cache 37 is allocated in the main memory 35. The storage device 34 is configured by a hard disk device, for example, and stores a database (data).

In the database management system 32, data is stored in the storage device 34 in a form of being divided every unit (for example, each being of a few kilobytes to a few tens of kilobytes) called block or page. On receiving a data read request from a client 36, the management device 33 reads out data responding to the data read request from the storage device 34, and after fairing the read data, returns the data to the client 36. If the data is estimated to have a high probability of being read again, the management device 33 stores the data into the buffer cache 37. The main memory 35 (buffer cache 37) is a storage device whose read-out speed is faster than that of the storage device (hard disk device) 34. Accordingly, on receiving the request (data read request) for reading out data being the same as data having been read out previously, the database management system 32 reads out the data not from the storage device 34 but from the main memory 35 (the buffer cache 37). As a result, the database management system 32 can increase the data read-out speed.

The estimation device 20 of the second exemplary embodiment is configured by a computer. As shown in FIG. 6, the estimation device 20 includes a processing device 21 and a storage device 22. In the second exemplary embodiment, before integrating databases (target databases), the estimation device 20 estimates a hit rate and a physical IO (Input Output) per second with respect to the database after the integration (integrated database), as the operation status of the integrated database. The hit rate is a probability that data responding to the data read request has been stored in the buffer cache. It is usual that a database is configured in a manner to achieve the hit rate larger than 90%. The physical IO per second (physical IO frequency) is a value representing a load on a storage device (hard disk device) storing data (a database). The physical IO per second (physical IO frequency) represents a number of data (the number of physical TO), per unit time (1 second, in the second exemplary embodiment), read from the storage device (hard disk device) in response to data read requests, (which is represented by the number of blocks, in the second exemplary embodiment). The physical IO per second is occasionally described as physical TOPS (Input Output Per Second).

Here, for the data read request issued from a client, a language for database called SQL (Structured Query Language) is used, for example. The SQL includes DDL (Data Definition Language), DML (Data Manipulation Language) and DCL (Data Control Language). The DDL is a data definition language for defining a data structure (table). The DML is a data manipulation language for manipulating data such as adding data to the database and searching the database. The DCL is a data control language for performing control of transaction and the like. In the second exemplary embodiment, attention is focused on data reading by the DML.

The storage device 22 included in the estimation device 20 is configured by, for example, a RAM (Random Access Memory) or a HDD (Hard Disk Drive). In the storage device 22, data for a format 38 and a program 39 are stored. The program 39 is a program representing a procedure of controlling operation of the estimation device 20. That is, the storage device 22 functions as a program storage medium storing the program 39.

The format 38 corresponds to a plurality of information (mainly in the form of equations, in the second exemplary embodiment) which are used while estimating the operation status of the integrated database. The format 38 is determined based on a following concept.

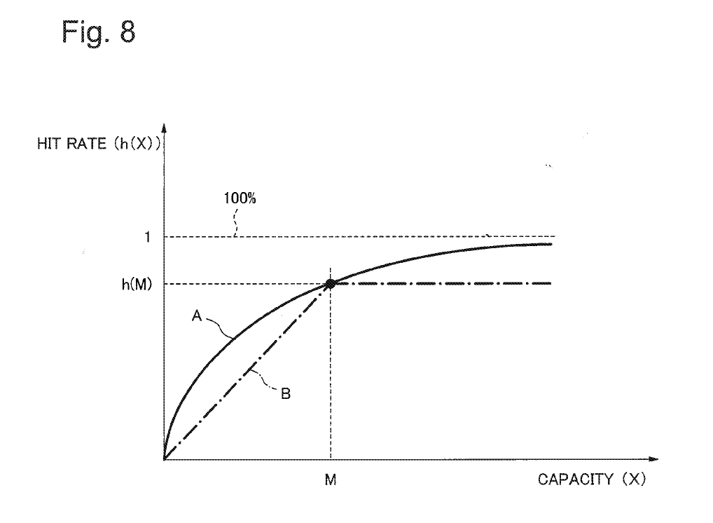

A generally relation between capacity X assigned as a buffer cache and the hit rate h(X) is represented by a solid curve A in FIG. 8. That is, the hit rate h(X) increases with increasing the capacity X in a region where the capacity X is small, but after reaching a certain amount of capacity, the trend (slope) of increase of the hit rate h(X) with reference to increase of the capacity X becomes smaller. Here, for simplification of a process, it is assumed that the relation between the capacity X and the hit rate h(X) is equivalent to ration represented by a relation shown by a dashed line B in FIG. 8 (hereafter, also referred to as a relation B), by performing conservative (pessimistic) estimation with respect to the hit rate h(X). The relation B can be expressed by a following equation (2).

$$h ( X ) = \{ \begin{matrix}( h ( M ) \text{/} M ) \times X & ( X ≦ M ) \\ h ( M ) & ( X > M )\end{matrix} \qquad ( 2 )$$

Where, the X in the equation (2) represents capacity. In the second exemplary embodiment, the M represents capacity actually assigned as the buffer cache. The h(M) represents the hit rate measured when the capacity is M.

The physical IO per second is the number of data (blocks) read out from a storage device (hard disk device) among data returned to a client in a unit time (that is, 1 second) (that is, the number of data not having been stored in the buffer cache). Accordingly, if the physical IO per second is represented by p, it can be expressed as in an equation (3).

p=r×(1−h(X)) (3)

Where, the r in the equation (3) represents the number of data read requests per unit time (that is, 1 second) issued from a client (hereafter, also referred to as a logical IO (Input Output) per second). The logical IO per second is occasionally described as logic TOPS (Input Output Per Second).

Based on the equations (2) and (3), the relation between the physical IO per second (p(X)) and the capacity (X) is expressed by an equation (4).

$$p ( X ) = \{ \begin{matrix}r \times ( 1 - ( h ( M ) \text{/} M ) \times X ) & ( X ≦ M ) \\ r \times ( 1 - h ( M ) ) & ( X > M )\end{matrix} \qquad ( 4 )$$

Here, it is assumed that the integrated database (for example, a database C) is constructed by integrating a plurality of databases to be the targets of the integration (for example, target databases A and B). In this case, in the integrated buffer cache C correlated to the integrated database C, the distribution ratio between the capacities used for data in the target database A and data in the target database B becomes equal to the ratio of the physical IO per second with respect to the target databases A and B. That is, in many cases, data in the buffer cache is managed by using an LRU (Least Recently Used) or an algorithm similar to the LRU. In the algorithm, data in the buffer cache is deleted in order of the number of read-outs from smallest to largest. The physical IO per second may also be an indicator of speed of rewriting the buffer cache with new data having been newly read from the storage device. In a case the server competitively rewrites data in a memory area shared by the plurality of target databases A and B, the distribution ratio of the memory area with respect to the target databases A and B becomes the same as the ratio of data rewriting speed, that is, the ratio of physical IO per second, between the databases.

Based on the above description, if assuming that the distribution ratio of the integrated buffer cache with respect to the target databases A and B is the same as the ratio of physical IO per second with respect to them, the relationship can be expressed as a following equation (5).

x:y=p_{A}(x):p_{B}(y) (5)

Where, the x in the equation (5) represents the capacity used for data of the target database A in the integrated buffer cache. The y represents the capacity used for data of the target database B in the integrated buffer cache. The p_{A}(x) represents the physical IO per second with respect to the target database A. The p_{B}(y) represents the physical IO per second with respect to the target database B.

The equation (5) can be modified as an equation (6).

x×p_{B}(y)=y×p_{A}(x) (6)

In a case that the capacity of the buffer cache allocated out of the main memory is represented by N, an equation (7) stands.

x+y=N (7)

By solving simultaneous equations consisting of the equations (6) and (7) using p_{A}(x) and p_{B}(y) obtained according to the equation (4), it is possible to calculate the capacities x and y used respectively in the capacity of the integrated buffer cache for data of the target databases A and B. Then, using the calculated capacities x and y and the equations (2) and (4), it is possible to calculate the hit rate and the physical IO per second, which correspond to the operation status of the integrated database.

In accordance with those described above, in the second exemplary embodiment, the storage device 22 stores, as the format 38, equations based on the equations (2), (4), (6) and (7).

The processing device 21 is configured by hardware resources including a CPU, for example. By reading and then executing the program 39 stored in the storage device 22, the processing device 21 realizes functional units described below. That is, the processing device 21 includes an acquisition unit (acquisition means) 24 and an estimation unit (estimation means) 25.

The acquisition unit 24 has a function to acquire information on the operation statuses of databases to be integrated together (for example, the target databases A and B) from the server of the database management system. The acquired information on operation statuses includes, with respect to each of the target databases A and B, information on the hit rate, the number of data read requests per unit time (1 second) (logical IO per second) and the buffer cache capacity.

Describing a specific example, the acquisition unit 24 acquires information on the operation status of the target database A that the buffer cache capacity is 1.0 GB, the hit rate of the buffer cache is 96% and the logical IO per second is 2000. The acquisition unit 24 also acquires, for example, information on the operation status of the target database B that the buffer cache capacity is 1.0 GB, the hit rate of the buffer cache is 92% and the logical IO per second is 3000.

The estimation unit 25 is provided with a function to estimate the operation status of the integrated database by using the information on the operation status of each of the databases to be integrated together which has been acquired by the acquisition unit 24. In the second exemplary embodiment, the estimation unit 25 includes an equation generation unit 27, a solution unit 28 and a calculation unit 29.

The equation generation unit 27 is provided with a function to generate equations according to the equations (6) and (7) mentioned above, based on the format 38 stored in the storage device 22 and the information on the operation status of each of the integration target databases A and B acquired by the acquisition unit 24. In other words, the equation generation unit 27 generates, based on the equation (6), an equation expressing a relationship between the operation status (physical IO per second value) of each of the target databases A and B and the capacity used in the integrated buffer cache for data of each of the target database A and B. The equation generation unit 27 also generates, based on the equation (7), an equation expressing a relationship between the capacity of the integrated buffer cache and the capacity used for data of the target databases A and B in the integrated buffer cache.

A specific example will be described below. Here, it is assumed, as described above, that the acquisition unit 24 has acquired the operation status of the target database

A where the buffer cache capacity M_{A} is 1.0 GB, the hit rate of the buffer cache h_{A}(M_{A}) is 96%, and the logical IO per second r_{A} is 2000. It is also assumed that the acquisition unit 24 has acquired the operation status of the target database B where the buffer cache capacity M_{B} is 1.0 GB, the hit rate of the buffer cache h_{B} (M_{B}) is 92%, and the logical IO per second r_{B} is 3000. It is further assumed that the capacity of the integrated buffer cache C correlated to the integrated database C into which the target databases A and B are to be integrated, which is represented by N, is 2.0 GB.

Under the above-described conditions, the equation generation unit 27 generates simultaneous equations shown as equations (8), on the basis of the equations (6) and (7).

$$\{ \begin{matrix}x \times {p}_{B} ( y ) = y \times {p}_{A} ( x ) \\ x + y = 2\end{matrix} \qquad ( 8 )$$

Further, based on the equations (2) and (4), equations (9) to (12) are obtained.

$$\begin{matrix}{h}_{A} ( x ) = \{ \begin{matrix}( {h}_{A} ( {M}_{A} ) \text{/} {M}_{A} ) \times x = ( 0.96 \text{/} 1.0 ) \times x & ( x ≦ 1.0 ) \\ {h}_{A} ( {M}_{A} ) = 0.96 & ( x > 1.0 )\end{matrix} & ( 9 ) \\ {p}_{A} ( x ) = \{ \begin{matrix}{r}_{A} \times ( 1 - ( {h}_{A} ( {M}_{A} ) \text{/} {M}_{A} ) \times x ) = 2000 \times ( 1 - ( 0.96 \text{/} 1.0 ) \times x ) & ( x ≦ 1.0 ) \\ {r}_{A} \times ( 1 - {h}_{A} ( {M}_{A} ) ) = 2000 \times ( 1 - 0.96 ) = 80 & ( x > 1.0 )\end{matrix} & ( 10 ) \\ {h}_{B} ( x ) = \{ \begin{matrix}( {h}_{B} ( {M}_{B} ) \text{/} {M}_{B} ) \times y = ( 0.92 \text{/} 1.0 ) \times y & ( y ≦ 1.0 ) \\ {h}_{B} ( {M}_{B} ) = 0.92 & ( y > 1.0 )\end{matrix} & ( 11 ) \\ {p}_{B} ( y ) = \{ \begin{matrix}{r}_{B} \times ( 1 - ( {h}_{B} ( {M}_{B} ) \text{/} {M}_{B} ) \times y ) = 3000 \times ( 1 - ( 0.92 \text{/} 1.0 ) \times y ) & ( y ≦ 1.0 ) \\ {r}_{B} \times ( 1 - {h}_{B} ( {M}_{B} ) ) = 3000 \times ( 1 - 0.92 ) = 240 & ( y > 1.0 )\end{matrix} & ( 12 )\end{matrix}$$

The solution unit 28 is provided with a function to solve the simultaneous equations generated by the equation generation unit 27. Specifically, for example, the solution unit 28 solves the simultaneous equations (8) taking the equations (9) to (12) into consideration. Here, as an algorithm for solving the simultaneous equations, for example, the algorithm of the Gauss method or the Gauss-Jordan method, which are described in Haruhiko Okumura, “Encyclopedia of the latest algorithms by C language”, Gijutsu-Hyoron Co., Ltd., February 1991, pp. 354-357, may be used.

In the second exemplary embodiment, by solving the simultaneous equations, the solution unit 28 can obtain values of x and y, that is, the capacities used respectively for data of the target database A and for data in B in the integrated buffer cache C. Based on the equations (8) to (12), the x is found to be 0.933 GB, and the y is found to be 1.07 GB.

The calculation unit 29 is provided with a function to further calculate the operation status of the integrated database by using the values of x and y calculated by the solution unit 28. For example, in the following way, the calculation unit 29 calculates the physical IO per second, the hit rate and a miss rate (probability that data responding to the data read request has not been stored in the buffer cache), which correspond to the operation status of the integrated database.

First, the calculation unit 29 substitutes the calculated values of the capacities x and y into the equations (9) to (12), thus calculating these equations. As a result, the operation status of the integrated database is estimated. Specifically, by substituting x=0.933 and y=1.07 into the equations (9) to (12) and then calculating the equations (9) to (12), the calculation unit 29 obtains the following result.

$$\{ \begin{matrix}{h}_{A} ( x ) = 0.895 & ( 89.5 \% ) \\ {p}_{A} ( x ) = 210 & \\ {h}_{b} ( y ) = 0.920 & ( 92 \% ) \\ {p}_{B} ( y ) = 240 & \end{matrix}$$

Then, by calculating p_{A+B}=p_{A}(x)+p_{B}(y), the calculation unit 29 finds the physical TO per second (p_{A+B}) with respect to the integrated database. For example, the calculation unit 29 finds the physical TO per second (p_{A+B}) to be 450, as a result of calculating it as 240+210.

Further, according to the equation (13), the calculation unit 29 calculates the miss rate (I_{A+B}) of the integrated buffer cache correlated to the integrated database.

$${I}_{A + B} = \frac{{p}_{A + B}}{{r}_{A} + {r}_{B}} \qquad ( 13 )$$

Where, the r_{A} in the equation (13) represents the logical TO per second with respect to the integration target database A. The r_{B} represents the logical TO per second with respect to the integration target database B.

Specifically, using the calculation result described above, the calculation unit 29 calculates a value of the miss rate as I_{A+B}=450/(2000+3000)=0.09 (9%).

Using the calculated miss rate, the calculation unit 29 further calculates a value of the hit rate h_{A+B} (h_{A+B}=1−I_{A+B}=0.91 (91%)).

In other words, in the second exemplary embodiment, the calculation unit 29 calculates the hit rate and the physical IO per second (physical IO frequency), as the operation status of the integrated database. Then, the calculated operation status is outputted to a predetermined sending destination (output destination).

As has been described above, the estimation device 20 of the second exemplary embodiment can estimate the operation status of the database after integration (the integrated database), such as the physical IO per second and the hit rate. For the estimation, the estimation device 20 uses measured values on the databases before the integration. Accordingly, the estimation device 20 can achieve, similarly to in the first exemplary embodiment, the effect that it can estimate, before database integration, the operation status of the integrated database to be constructed by the integration.

### Other Exemplary Embodiments

The present invention is not limited to the first and second exemplary embodiments, and can be implemented as various exemplary embodiments. For example, in the second exemplary embodiment, the simultaneous equations generated by the equation generation unit 27 are the simultaneous equations based on a condition that the capacity of the integrated buffer cache correlated to the integrated database is fixed (the equation (8) is referred to). Alternatively, for example, the equation generation unit 27 may generate simultaneous equations shown below as equations (14), under a condition that the physical IO per second with respect to the integrated database (pₛ) is fixed.

$$\{ \begin{matrix}x \times {p}_{B} ( y ) = y \times {p}_{A} ( x ) \\ {p}_{A} ( x ) + {p}_{B} ( y ) = {p}_{S} \end{matrix} \qquad ( 14 )$$

Where, the pₛ in the equations (14) is an invariable representing the physical IO per second demanded of the integrated database.

Then, the solution unit 28 solves the simultaneous equations (14) using, for example, an algorithm similar to that already described above. Using the calculation result, also similarly to in the description already given above, the calculation unit 29 calculates the physical IO per second with respect to the integrated database, and further calculates the hit rate. In this way, for example, in a case that the upper limit of the processing capacity (p<SUB>S</SUB>) of the hard disk device is predetermined, the amount of capacity necessary to be secured for the buffer cache after integration is calculated.

In the second exemplary embodiment, an example of integrating the two target databases A and B has been described as the specific example. Alternatively, also in a case of constructing the integrated database by integrating three or more target databases, the operation status of the integrated database can be estimated by applying the second exemplary embodiment.

For example, because the ratio (the distribution ratio) among the capacities used for data of respective target databases being the integration targets in the integrated buffer cache is the same as the ratios among the physical IO per second values with respect to the respective target databases, the equation generation unit 27 generates simultaneous equations shown below as equations (15). Here, in the case of constructing the integrated database by integrating three target databases A, B and C, the x, the y and the z in the equations (15) represents the capacities used for data of the respective databases in the integrated buffer cache correlated to the integrated database. The S represents the capacity of the integrated buffer cache correlated to the integrated database. The p_{A}(x), p_{B}(Y) and p_{C}(z) represents respectively the physical IO per second values with respect to the three databases being the integration targets.

$$\{ \begin{matrix}x \times {p}_{B} ( y ) = y \times {p}_{A} ( x ) \\ y \times {p}_{C} ( z ) = z \times {p}_{B} ( y ) \\ x + y + z = S\end{matrix} \qquad ( 15 )$$

By the solution unit 28 solving the simultaneous equations (15) and the calculation unit 29 then performing calculation using the obtained solution similarly to in the description already given above, the estimation unit 25 can calculate the operation status of the integrated database similarly to in the description given above.

As has been described above, the present invention can be applied to the case of constructing the integrated database by integrating three or more target databases.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2012-201748, filed on Sep. 13, 2012, the disclosure of which is incorporated herein in its entirety by reference.

### INDUSTRIAL APPLICABILITY

The present invention is an effective technology for a database system capable of storing and managing a huge amount of data.

### REFERENCE SIGNS LIST

1, 20 estimation device
2, 24 acquisition unit
3, 25 estimation unit
27 equation generation unit
28 solution unit

What is claimed is:

1. An estimation device, comprising:
an acquisition unit that acquires information on an operation status of each of databases which are integration targets to be integrated; and
an estimation unit that generates, by using the acquired operation status, an equation expressing a relationship between the operation status of the database to be the integration target and capacity of a buffer cache correlated to the database, and then estimating an operation status of an integrated database generated by integrating the plurality of databases to be the integration targets, based on the generated equation and capacity of an integrated buffer cache which is correlated to the integrated database.

2. The estimation device according to claim 1, wherein the acquisition unit acquires, as the operation status of the database to be the integration target, a hit rate which is a probability that data responding to a data read request to the database to be the integration target has been stored in the buffer cache, and
the estimation unit generates, as the equation, an equation expressing a relationship between the obtained hit rate and the capacity of the buffer cache, and then using the equation, estimates the operation status of the integrated database.

3. The estimation device according to claim 2, wherein the acquisition unit further acquires, as the operation status of the database to be the integration target, data read request frequency which is the number of data read requests per unit time, and
the estimation unit calculates, by using the data read request frequency and the hit rate obtained by the acquisition unit, physical IO (Input Output) frequency which is the number per unit time of the data read requests that the data in response to the data read requests is not been stored in the buffer cache, as the operation status of the database to be the integration target, and further, the estimation unit generates also an equation expressing a relationship between the physical IO frequency and the capacity of the buffer cache, and then using also the equation, estimates an operation status of the integrated database.

4. The estimation device according to claim 3, wherein the estimation unit estimates the operation status of the integrated database by generating by using the equation and the capacity of the integrated buffer cache, based on a condition that ratio of the physical IO frequency with respect to respective databases to be the integration targets is equal to ratio of capacity occupied in the integrated buffer cache by the respective databases to be the integration targets, simultaneous equation giving as the solutions each capacity occupied in the integrated buffer cache by the respective databases to be the integration targets or each physical IO frequency with respect to the respective databases to be the integration targets, and solving the simultaneous equation.

5. The estimation device according to claim 1, wherein the estimation unit generates the equation using a format for generating the equation.

6. A database operation status estimation method, comprising:
acquiring, by a computer, information on an operation status of each of databases which are integration targets to be integrated;
generating, by a computer, an equation expressing a relationship between the operation status of the database to be the integration target and capacity of a buffer cache correlated to the database based on the acquired operation status; and
estimating, by a computer, an operation status of an integrated database generated by integrating the plurality of databases to be the integration targets, based on the generated equation and capacity of an integrated buffer cache which is correlated to the integrated database.

7. A computer program storage medium, the computer program storage medium stores a computer program that cause a computer to execute:
processing to acquire information on an operation status of each of databases which are integration targets to be integrated;
processing to generate, by using the acquired operation status, an equation expressing a relationship between the operation status of the database to be the integration target and capacity of a buffer cache correlated to the database; and
processing to estimate an operation status of an integrated database generated by integrating the plurality of databases to be the integration targets, based on the generated equation and capacity of an integrated buffer cache which is correlated to the integrated database.

8. An estimation device, comprising:
acquisition means for acquiring information on an operation status of each of databases which are integration targets to be integrated; and
estimation means for generating, by using the acquired operation status, an equation expressing a relationship between the operation status of the database to be the integration target and capacity of a buffer cache correlated to the database, and then estimating an operation status of an integrated database generated by integrating the plurality of databases to be the integration targets, based on the generated equation and capacity of an integrated buffer cache which is correlated to the integrated database.
